(19) United States
(12) Patent Application Publication
(10) Pub. No.: US 2018/0009465 A1
(43) Pub. Date: Jan. 11, 2018

(54) DEVICE AND METHOD OF CONTROLLING STEERING SYSTEM MOUNTED IN VEHICLES

(71) Applicant: DENSO CORPORATION, Kariya-city (JP)

(72) Inventors: Takashi AOKI, Kariya-city (JP); Daiji WATANABE, Kariya-city (JP)

(21) Appl. No.: 15/637,167

(22) Filed: Jun. 29, 2017

(30) Foreign Application Priority Data
Jul. 5, 2016 (JP) 2016-133100

(51) Int. Cl. B62D 5/04; B62D 5/00; B62D 1/04

(52) U.S. Cl. CPC B62D 5/0463; B62D 1/04; B62D 5/001

(57) ABSTRACT

A steering control device controls an assist torque to be outputted by a motor connected to a steering system mechanism generating a steering torque. A response compensation filter performs a filter process compensating for a response in a specific frequency band with respect to a target steering torque generated by a target generation unit, and outputs a response-compensated target steering torque (Ts**). A servo controller calculates an assist torque command value (Ta*) in order for a torque deviation (ΔTs), which is a difference between the steering torque (Ts) and the response-compensated target steering torque (Ts**), to become zero. A transfer characteristic of the response compensation filter is set to suppress a mechanical resonance frequency band where a gain due to resonance of the steering system mechanism becomes large.

### CROSS-REFERENCE TO RELATED APPLICATION

This application is based on and claims the benefit of priority from earlier Japanese Patent Application No. 2016-133100 filed Jul. 5, 2016, the description of which is incorporated herein by reference.

### BACKGROUND

### Technical Field

The present invention relates to a device and a method of controlling a steering system mounted in vehicles.

### Related Art

In a conventional technology, a steering control device calculating an assist amount by controlling a steering torque to be arranged in correspondence to a target steering torque is known. For example, in the case of a device disclosed in Patent Document 1, a target generation unit calculates the target steering torque based on an estimated load and a vehicle speed. A controller unit calculates the assist amount in order for a torque deviation, which is a difference between the target steering torque and the steering torque, to become zero.

### RELATED ART DOCUMENTS

### Patent Document

### [Patent Document 1] Patent Application Publication No. 5533822

The above information disclosed in this Background section is only to enhance the understanding of the background of the invention and therefore it may contain information that does not form the prior art that is already known to a person of ordinary skill in the art.

According to a technology disclosed in Patent Document 1, since a transfer characteristic from a target steering torque to a steering torque has small degrees of adjustment freedom, there is a possibility that a characteristic due to resonance of a steering system mechanism may be included therein or a response characteristic that suits a sensitivity of a driver may not be obtained thereby.

Furthermore, when the transfer characteristic from the target steering torque to the steering torque is configured to be a desired characteristic, a high-order transfer function (for example, an eighth-order transfer function) becomes required such that fine adjustment after on-board installation and providing modifications become difficult. In addition, since a controller calculating an assist amount should be operated in a high-gain mode, a safety margin degree of a control system becomes small such that vibration may easily occur.

### SUMMARY

Hence it is desired to secure control stability, and to provide a steering control device and a steering control method for improving a steering feeling in operating a steering system mounted in vehicles.

A device and method of controlling an assist torque in steering system mounted in vehicles are provided in exemplary embodiments, in which the device is referred to as the steering control device. The assist torque is outputted by a motor connected to a steering system mechanism generating a steering torque.

The steering control device is provided with a target generation unit, a response compensation filter, and a servo controller.

The target generation unit generates a target steering torque, which is a target value of the steering torque.

The response compensation filter performs a filter process compensating for a response at a specific frequency band with respect to an inputted target steering torque, and outputs a response-compensated target steering torque, which is a target steering torque whose response in the specific frequency band is compensated.

A servo controller calculates an assist torque command value Ta* in order for a torque deviation, which is a difference between the steering torque and the target steering torque after compensating for the response, to become zero.

Furthermore, the servo controller corresponds to an assist controller described in Patent Document 1.

A transfer characteristic of the response compensation filter is set to suppress a mechanical resonance characteristic at a frequency band having the mechanical resonance characteristic where a gain due to resonance of the steering system mechanism becomes great, with respect to the transfer characteristic from the target steering torque to the steering torque.

The device and method according to an exemplary embodiment is characterized in that a gain at a specific frequency band of the target steering torque is increased or decreased according to the response compensation filter. More specifically, the response compensation filter suppresses a gain of a transfer characteristic at the frequency band where the mechanical resonance characteristic occurs. Accordingly, a rough feeling in the process of steering caused by the mechanical resonance may be decreased, thereby improving the steering feeling.

Generally, the response compensation as described above is configured to set the transfer characteristic from the target steering torque to the steering torque flat. On the contrary, when the transfer characteristic is intended to be flat without using the response compensation filter, the servo controller should be operated in a high-gain mode. Otherwise, control may become unstable. According to the exemplary embodiment, control stability is able to be improved by using the response compensation filter.

Additionally, in comparison with a configuration where a desired transfer characteristic is accomplished by a high-order transfer function, the servo controller is able to be operated in low order by using the response compensation filter. Therefore, on-board installation of the servo controller becomes easy, and thus consequently application technologies such as output limitation of an assist torque command, a dead band process, and the like become easy to be applied.

Preferably, the transfer characteristic of the response compensation filter is set to increase a gain of the transfer characteristic from the target steering torque to the steering torque at a band of a frequency side lower than a frequency band suppressing the mechanical resonance characteristic. Accordingly, responsiveness is improved by suiting a sensitivity of a driver, thereby improving steering response.

Furthermore, the transfer characteristic of the response compensation filter is also able to be set to increase the gain of the transfer characteristic from the target steering torque to the steering torque at a band of a frequency side higher than the frequency band suppressing the mechanical resonance characteristic.

### BRIEF DESCRIPTION OF THE DRAWINGS

In the accompanying drawings:

FIG. 1 is a drawing illustrating a schematic configuration of an electric power steering system.

FIG. 2 is a drawing illustrating a configuration of an ECU (a steering control device) according to respective exemplary embodiments of the present invention.

FIG. 3 is a drawing illustrating a configuration example of a response compensation filter.

FIG. 4 is a model drawing illustrating an input and output of a transfer characteristic.

FIG. 5 is a drawing illustrating a transfer characteristic of a response compensation filter according to a first exemplary embodiment of the present invention.

FIGS. 6A and 6B are drawings illustrating a transfer characteristic from a target steering torque to a steering torque according to the first example embodiment of the present invention.

FIGS. 7A and 7B are drawings illustrating a transfer characteristic of a response compensation filter according to (A) of a second exemplary embodiment of the present invention and (B) of a third exemplary embodiment of the present invention.

FIGS. 8A and 8B are drawings illustrating a transfer characteristic from a target steering torque to a steering torque according to (A) of the second exemplary embodiment of the present invention and (B) of the third exemplary embodiment of the present invention.

FIGS. 9A and 9B are drawings illustrating other configuration examples of a response compensation filter.

### DETAILED DESCRIPTION OF THE EMBODIMENTS

Specifically structural or functional description with respect to exemplary embodiments of the present invention disclosed in the specification is illustrated only for the purpose of describing the exemplary embodiments of the present invention, and the exemplary embodiments of the present invention may be modified in various different ways, all without departing from the spirit or scope of the present invention.

As the exemplary embodiments of the present invention may be modified in various different ways and may have various modifications, the exemplary embodiments is illustrated on the drawings and is described in detail in the specification

However, the exemplary embodiments of the present invention should not be limited to the specifically disclosed forms, and are intended to cover various modifications and equivalent arrangements, or substitutes included within the spirit and technology scope of the present invention.

The terms used in the specification are only used to describe the specific exemplary embodiments and are not intended to limit the present invention.

As used herein, the singular expressions “a”, “an” and “the” are intended to include the plural expressions as well, unless the context clearly indicates otherwise.

Preferred embodiments will be described more fully hereinafter with reference to the accompanying drawings, in which a plurality of exemplary embodiments of a steering control device are shown. According to the respective exemplary embodiments, an ECU (electronic control unit) as the steering control device is applied to an electric power steering system of a vehicle, and then outputs an assist torque command at a motor generating a steering assist torque.

### [Configuration of an Electric Power Steering System]

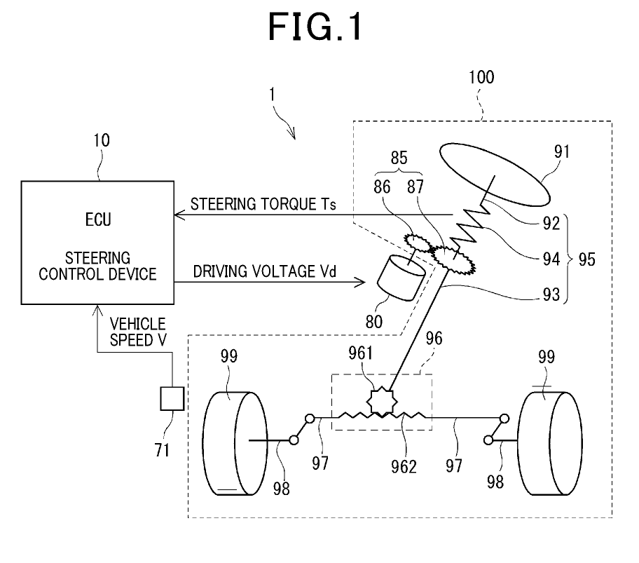

As shown in FIG. 1, an electric power steering system 1 is configured to assist operation of a steering wheel (handle) 91 by a driver according to a torque of a steering assist motor 80.

The steering wheel (handle) 91 is fixed at one end of a steering shaft 92, and an intermediate shaft 93 is installed at the other end of the steering shaft 92. A torque sensor 94 is installed between the steering shaft 92 and the intermediate shaft 93. The steering shaft 92 and the intermediate shaft 93 are connected by a torsion bar of the torque sensor 94.

Hereinafter, a whole axis from the steering shaft 92 to the intermediate shaft 93 via the torque sensor 94 is altogether described as a steering shaft 95.

The torque sensor 94 detects a steering torque Ts. The torque sensor 94 includes the torsion bar connecting the steering shaft 92 and the intermediate shaft 93, and detects a torque applied to the torsion bar based on a twist angle of the torsion bar. A detection value of the torque sensor 94 is outputted at the ECU 10 as the detection value in connection with the steering torque Ts.

A gear box 96 is installed at the torque sensor 94 of the intermediate shaft 93 and an end portion of the other side. The gear box 96 includes a pinion gear 961 and a rack 962. The pinion gear 961 is installed at the torque sensor 94 of the intermediate shaft 93 and the end portion of the other side, and is engaged with teeth of the rack 962.

When a driver turns the steering wheel 91, the intermediate shaft 93 and the pinion gear 961 are rotated, and the rack 962 is moved from side to side according to a rotation of the pinion gear 961.

A tie rod 97 is installed at both ends of the rack 962. The tie rod 97 performs a reciprocating motion from side to side together with the rack 962. The tie rod 97 is connected to a steering wheel 99 through a knuckle arm 98. The tie rod 97 pulls and pushes the knuckle arm 98 such that a direction of the steering wheel 99 is changed.

For example, the motor 80 is a three-phase alternating current brushless motor, and outputs the assist torque assisting a steering force of the steering wheel 91 according to a driving voltage Vd outputted from the ECU 10. In the case of a three-phase alternating current motor, the driving voltage Vd means respective phase voltages of an U-phase, a V-phase, and a W-phase.

A rotation of the motor 80 is transmitted to the intermediate shaft 93 via a speed reducer 85.

Furthermore, the electric power steering system 1 shown in FIG. 1 is a column-assist type where the rotation of the motor 80 is transmitted to the steering shaft 95. Meanwhile, the ECU 10 according to an exemplary embodiment of the present invention is able to be applied to an electric power steering system of a rack-assist type or equally able to be applied to a steer-by-wire system where the steering wheel (handle) and the steering wheels are mechanically separated.

Additionally, according to other exemplary embodiments, a multiphase alternating current motor other than the three-phase alternating current motor, and a DC motor with a brush are able to be used as the steering assist motor.

The speed reducer 85 includes a worm gear 86 and a worm wheel 87. The worm gear 86 is installed at a tip of the rotation axis of the motor 80. The worm wheel 87 is installed at the same axis as the intermediate shaft 93 in a state where the worm wheel 87 is engaged with the worm gear 86. Accordingly, the rotation of the motor 80 is transmitted to the intermediate shaft 93. Additionally, when the intermediate shaft 93 is rotated by the steering of the steering wheel 91 and by a reactive force from a road surface, the rotation is transmitted to the motor 80 via the speed reducer 85 such that the motor 80 is rotated.

Here, a whole mechanism, to which the steering force of the steering wheel 91 exerted from the steering wheel 91 to the steering wheels 99 is transmitted, is referred to as a steering system mechanism 100. The ECU 10 controls the steering torque Ts generated by the steering system mechanism 100 by controlling the assist torque to be outputted by the motor 80 connected to the steering system mechanism 100.

The steering mechanism 100 is a configuration where various mechanical components including a spring are connected, and includes a specific resonance frequency. In general, a resonance frequency band of the steering system mechanism 100 ranges from about 10 Hz to 20 Hz.

Furthermore, a vehicle speed sensor 71 detecting a vehicle speed V is installed at a predetermined position of a vehicle.

The ECU 10 is operated by electric power from an in-vehicle battery (not shown), and calculates an assist torque command value Ta* based on the steering torque Ts detected by the torque sensor 94, the vehicle speed V detected by the vehicle speed sensor 71, and the like. Additionally, the ECU 10 generates the steering torque Ts in the steering system mechanism 100 by applying the driving voltage Vd calculated based on the assist torque command value Ta* to the motor

[ECU Configuration]

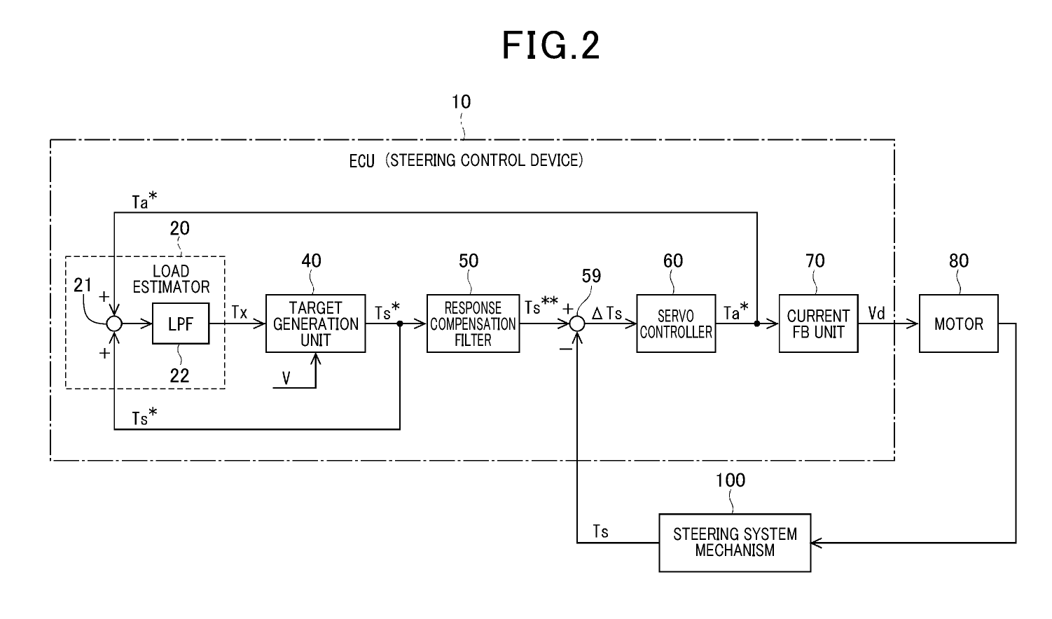

As shown in FIG. 2, the ECU 10 is provided with a load estimator 20, a target generation unit 40, a response compensation filter 50, a deviation calculator 59, a servo controller 60, a current feedback (abbreviated as “FB” in drawings) unit 70, and the like.

Various calculation processes in the ECU 10 are able to be performed as a software process by operating a program previously stored in a substantive memory device such as a ROM, and the like by means of CPU, and also able to be performed as a hardware process by means of an exclusive electronic circuit.

The load estimator 20 includes an adder 21 and a low-pass filter (abbreviated as “LPF” in drawings) 22. According to an exemplary embodiment shown in FIG. 2, the adder 21 adds the assist torque command value Ta* and the target steering torque Ts*. The low-pass filter 22 extracts a predetermined frequency, which is, for example, a band component lower than 10 Hz, from an added torque. The load estimator 20 outputs a frequency component extracted by the low-pass filter 22 as an estimation load TX

The target generation unit 40 generates the target steering torque Ts*, which is a target value of the steering torque Ts, by using an assist map disclosed in Patent Document 1 on the basis of the estimation load TX estimated by the load estimator 20 and the vehicle speed V. Meanwhile, in the case of a vehicle speed other than mapped vehicle speed V, the target steering torque Ts* is acquired by interpolating a map value.

The response compensation filter 50 has a unique configuration in the exemplary embodiment of the present invention.

The response compensation filter 50 performs a filter process compensating for a response at a specific frequency band with respect to the inputted target steering torque Ts*, and outputs a response-compensated target steering torque Ts**, which is a target steering torque whose response in the specific frequency band is compensated. A detailed example of the transfer characteristic describing a relationship between an input of the response compensation filter 50 and an output thereof is described later.

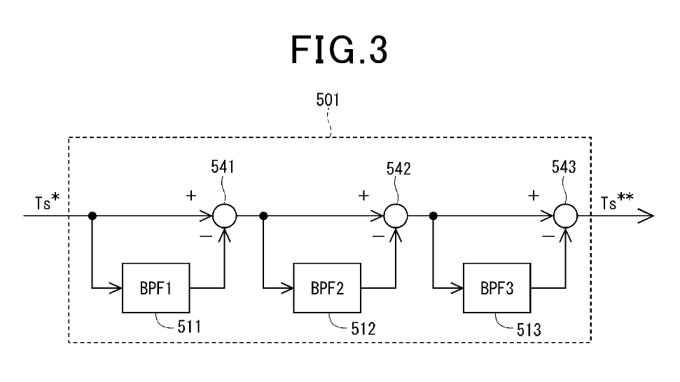

One example of a configuration of the response compensation filter 50 is shown in FIG. 3.

The response compensation filter 50 shown in FIG. 3 is configured by combining a plurality of band-pass filters (abbreviated “BPF” in drawings) 511, 512, and 513. Each of the band-pass filters 511, 512, and 513 is configured as a second-order filter, which is a low-order filter, and then passes inputted signals of frequency bands different with each other.

In a configuration shown in FIG. 3, a value, where an output of each of the band-pass filters 511, 512, and 513 is subtracted from each inputted signal, is outputted at subtractors 541, 542, and 543 to be connected in series.

The deviation calculator 59 calculates a torque deviation ΔTs (=Tx**−Ts), which is a difference between the steering torque Ts detected by the torque sensor 94 and the response-compensated target steering torque Ts**.

The servo controller 60 corresponds to the assist controller disclosed in Patent Document 1. The servo controller 60 operates a servo control and calculates the assist torque command value Ta* in order for the torque deviation ΔTs to become zero, that is, in order for the steering torque Ts to follow the response-compensated target steering torque Ts**.

A current feedback unit 70 applies the driving voltage Vd to the motor 80 in order for the assist torque according to the assist torque command value Ta* to be particularly provided to a torque axis 95 of a side of the steering wheel 99 rather than the torque sensor 94.

More specifically, the current feedback unit 70 includes power conversion circuits such as a current feedback control circuit, a driving circuit, an inverter, and the like.

The current feedback control circuit calculates a target current supplied to respective phases of the motor 80 based on the assist torque command value Ta*, and calculates respective phase voltage commands by feed-backing an actual current with respect to the target current. The driving circuit commands a driving signal switching an inverter by means of PWM (pulse width modulation) control, and the like based on a voltage command. The inverter converts electric power inputted by a battery, and the like by performing switching operation according to a plurality of the driving signals, and outputs the driving voltage Vd for generating a desired assist torque at the torque axis 95.

A current feedback control technology described above is a well-known technology in the field of a motor control, so detailed descriptions are omitted.

Next, an interaction effect of the ECU 10 according to the above-mentioned configuration is described by “a transfer characteristic of the response compensation filter” and “a transfer characteristic from the target steering torque to the steering torque”.

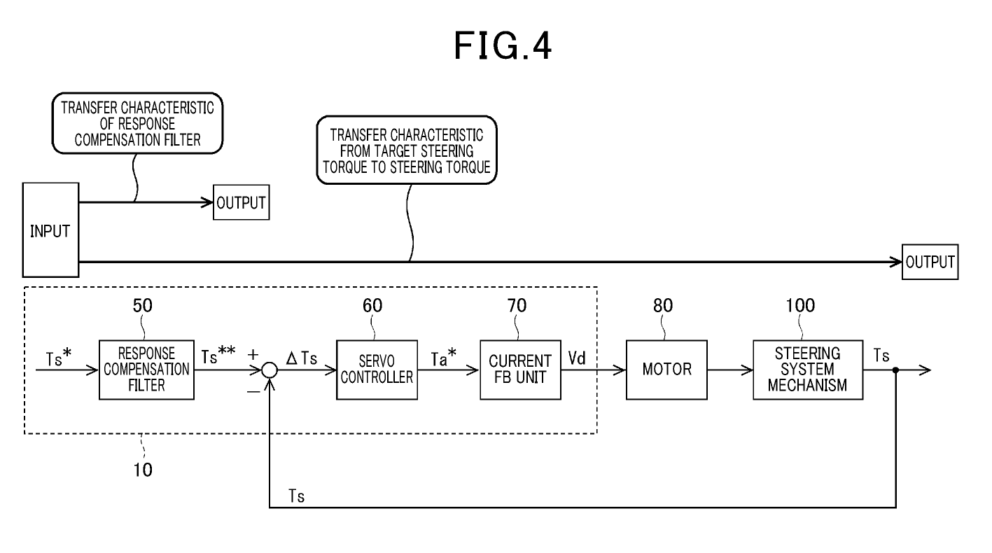

As shown in FIG. 4, the transfer characteristic of the response compensation filter is a frequency characteristic of a transfer function by which the target steering torque Ts* is inputted and the response-compensated target steering torque Ts** is outputted. The transfer characteristic from the target steering torque to the steering torque is a frequency characteristic of a transfer function by which the target steering torque Ts* is inputted and the steering torque Ts generated by the steering system mechanism 100 is outputted.

Here, an increase and a decrease of a gain as the frequency characteristics are mainly focused, and a phase is not described.

With respect to the gain, the characteristics thereof are described based on viewpoints where an input is amplified by a positive gain with a dB unit and an input is suppressed by a negative gain with a dB unit on the basis of 0 [dB], that is, 1 time. Hereinafter, a description, where the gain is positive/negative, uses dB as units.

When the transfer characteristic of the response compensation filter is a flat characteristic of the gain 0 [dB] over entire frequency bands, the response compensation filter 50 outputs the inputted target steering torque Ts* substantially unchanged as the response-compensated target steering torque Ts**. That is, substantial response compensation is not performed.

Meanwhile, with respect to the flat characteristic of the gain 0 [dB], in the case of the transfer characteristic where the gain is increased in a positive direction at a specific band, the response compensation filter 50 outputs the inputted target steering torque Ts* as the response-compensated target steering torque Ts** amplified at the specific band. On the contrary, in the case of the transfer characteristic where the gain is decreased in a negative direction at a specific band, the response compensation filter 50 outputs the inputted target steering torque Ts* as the response-compensated target steering torque Ts** suppressed at the specific band.

Hereinafter, with respect to the transfer characteristic of the response compensation filter, a description, where the gain is increased or decreased, means increasing or decreasing the gain from 0 [dB], that is, 1 time.

Furthermore, three specific examples with respect to “the transfer characteristic of the response compensation filter” and “the transfer characteristic from the target steering torque to the steering torque” corresponding thereto are described as exemplary embodiments 1 to 3.

### First Exemplary Embodiment

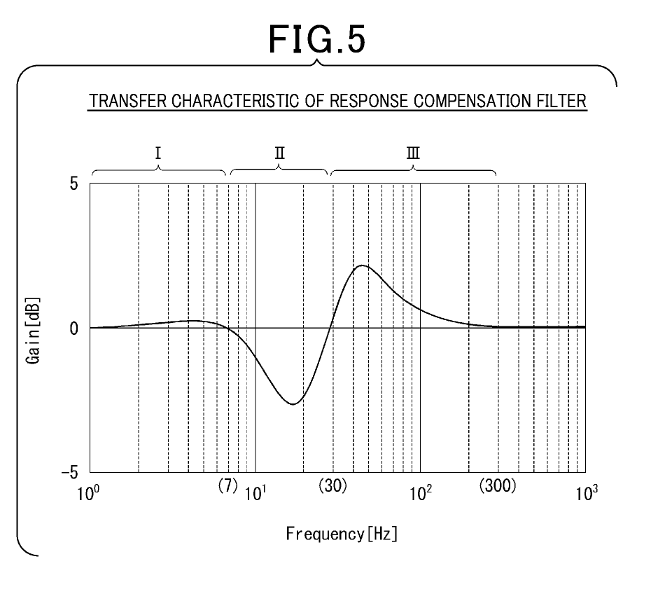

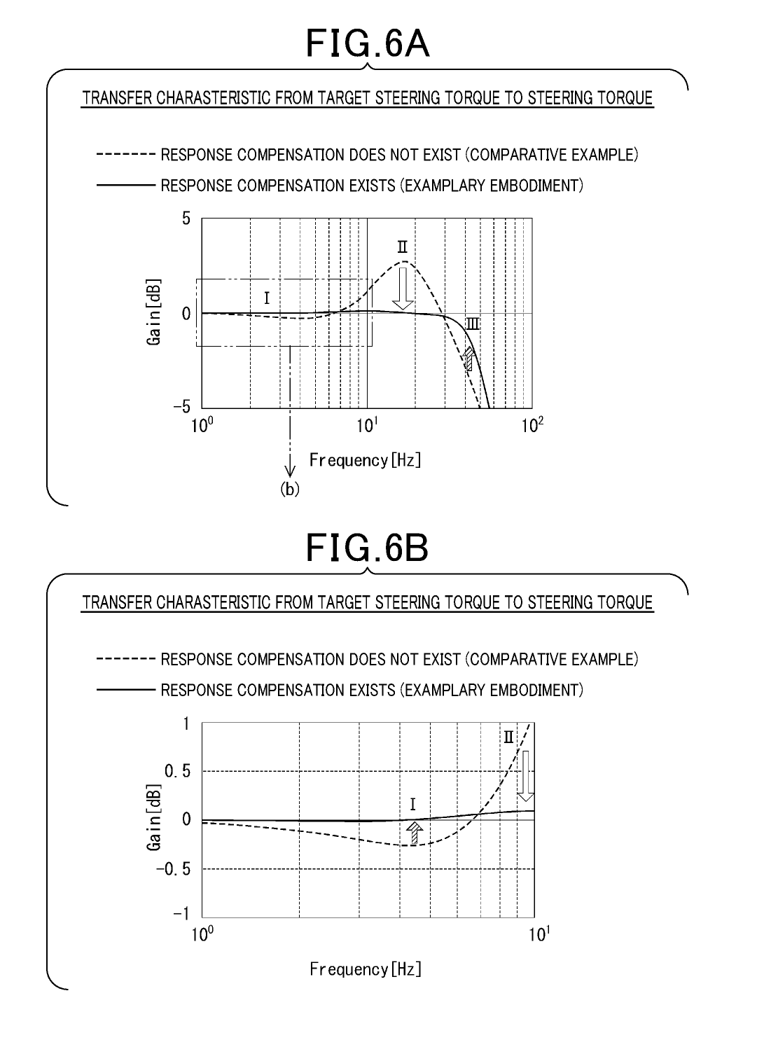

The transfer characteristic of the response compensation filter in a first exemplary embodiment is shown in FIG. 5 and the transfer characteristic from the target steering torque to the steering torque is shown in FIGS. 6A and 6B. FIG. 6A is a drawing illustrating characteristics in a frequency band ranging from 1-100 Hz. FIG. 6B is an enlarged drawing illustrating a band ranging from 1-10 Hz of FIG. 6A.

FIGS. 6A and 6B show a transfer characteristic described with a solid line when a response compensation exists according to an exemplary embodiment of the present invention.

Furthermore, as a comparative example, when the response compensation does not exist, a transfer characteristic is described with a broken line. The comparative example corresponds to a conventional technology disclosed in Patent Document 1 where the response compensation filter is not provided.

The transfer characteristic of the comparative example is shown as follows:

a gain at a band ranging from about 1 to 7 Hz becomes negative; a gain at a band ranging from about 7 to 30 Hz becomes positive; and a gain at a band higher than about 30 Hz becomes negative with a continuous curved line.

The negative gain at the band ranging from about 1 to 7 Hz is slightly smaller than 0 [dB], and is considered that a response of the steering torque Ts with respect to the target steering torque Ts* is slightly decreased.

The positive gain at the band ranging from about 7 to 30 Hz shows a mountain shape where about 18 Hz, i.e., lower than 20 Hz, is a peak. A characteristic of the mountain shape is taken place by resonance of the steering system mechanism 100. Hereinafter, a resonance characteristic of the steering system mechanism 100 is referred to as a mechanical resonance characteristic.

As a frequency becomes higher, a gain sharply becomes lower in a high frequency-side band according to the peak of the mountain shape characteristic. Furthermore, the gain performs a zero-cross function at about 30 Hz and the gain becomes a negative value in a band higher than 30 Hz. That is, as the frequency becomes higher, the response becomes lower at the band of the high frequency side of a resonance characteristic band, and an output of the steering torque Ts becomes small in comparison with the target steering torque Ts*.

In addition, responsiveness at the high frequency band more than from dozens of Hz to 100 Hz has a relatively small influence on a steering feeling. Thus, a characteristic of the high frequency higher than about 50 Hz is not hereinafter described.

As described above, in the case of a steering control device, which is not provided with the response compensation filter, of the comparative example, the target steering torque Ts* is not transferred to the steering torque Ts without being altered, and transfer characteristics to be influenced by a mechanical resonance characteristic and lower responsiveness exist.

Consequently, a driver may have a rough feeling in the process of steering caused by the mechanical resonance and may feel a dull response due to the lower responsiveness.

Here, the response compensation filter 50 in the exemplary embodiment is configured to compensate for the response so as to suppress the influence of the mechanical resonance characteristic and the influence of the lower responsiveness by inputting the target steering torque Ts*.

The transfer characteristic of the response compensation filter according to the first exemplary embodiment is set as follows:

(I) A gain is to be slightly increased in a band ranging from about 1 to 7 Hz;

(II) A gain is to be relatively significantly decreased in a band ranging from about 7 to 30 Hz with a negative peak of about 18 Hz; and

(III) A gain is to be relatively significantly increased in a band ranging from about 30 to 300 Hz with a positive peak ranging from about 40 to 50 Hz.

Accordingly, the transfer characteristic from the target steering torque to the steering torque according to the first exemplary embodiment is changed with respect to the transfer characteristic of the comparative example as follows:

Changes of (I) and (III) are shown with a hatched block arrow, and a change of (II) is shown with an outlined block arrow in FIGS. 6A and 6B.

(I) The gain becomes flat, almost 0 [dB], at the band ranging from about 1 to 7 Hz. That is, in comparison with the case where the response compensation does not exist, the gain is slightly increased in a direction of 0 [dB], that is, in a direction approaching 1 time from negative, that is, a state lower than 1 time. Accordingly, the responsiveness is improved, and thus consequently a response in the process of the steering is improved.

(II) The gain also becomes flat, almost 0 [dB], at the band ranging from about 7 to 30 Hz. In comparison with the case where the response compensation does not exist, the gain is slightly decreased in a direction of 0 [dB], that is, in a direction approaching 1 time from positive, that is, a state higher than 1 time. In this case, a reduction degree is as large as about 20 Hz, which is the peak of the mountain shape. Accordingly, the mechanical resonance characteristic is suppressed, thereby reducing the rough feeling in the process of the steering.

(III) As the frequency becomes higher, the gain linearly becomes lower in the band ranging from about 30 to 60 Hz. In this case, a right-down characteristic line is offset at a high gain side with respect to the characteristic line of the comparative example. Accordingly, the responsiveness is improved, thereby improving the response in the process of steering

In the first exemplary embodiment, a band (II) is a frequency band suppressing the mechanical resonance characteristic. Additionally, a band (I) corresponds to a band of a frequency side lower than the frequency band suppressing the mechanical resonance characteristic, and a band (III) corresponds to a band of a frequency side higher than the frequency band suppressing the mechanical resonance characteristic. The responsiveness is improved in the bands (I) and (III).

Accordingly, in the case of the transfer characteristic from the target steering torque to the steering torque according to the first exemplary embodiment, the gain becomes flat, almost 0 [dB], at a frequency band ranging from about 1 to 30 Hz. That is, the transfer characteristic of the response compensation filter is set to be in the state described above. Therefore, the steering torque Ts to be outputted by the steering system mechanism 100 almost corresponds to the target steering torque Ts* at the frequency band ranging from about 1 to 30 Hz, such that the steering feeling is able to be improved.

Meanwhile, in the case of a configuration of the exemplary embodiment, since the servo controller 60 is not required to be operated with a high gain, control stability is able to be improved. Furthermore, the servo controller 60 is able to be set in a lower order by using the response compensation filter 50 such that on-board installation of the servo controller 60 becomes easy.

Here, a technology, where an output of the assist torque command value Ta* at the servo controller 60 is limited, has been disclosed in Patent Application Publication No. 2014-237375. Furthermore, a technology, where the assist torque command value Ta* is processed as a dead band when an inputted absolute value based on the torque deviation ΔTs is smaller than a predetermined value at the servo controller 60, has been disclosed in Patent Application Publication No. 2015-33941. Accordingly, the on-board installation of the servo controller 60 becomes easy such that the application technologies thereof become easy to be applicable.

Additionally, referring to a response compensation filter 501 shown in FIG. 3, on-board installation of the response compensation filter becomes easy by configuring the response compensation filter in a way that low band-pass filters 511, 512, and 513 are combined.

Furthermore, as shown in FIG. 5, since the transfer characteristic of the response compensation filter is easy to be intuitively understood, a setting is easy. Also, since target value following performance (target value followability) and disturbance suppression performance, that is, the performance where a discrepancy from a target value hardly occurs when a disturbance is inputted, are able to be independently secured, a high performance control is able to be easily accomplished.

### Second and Third Exemplary Embodiments

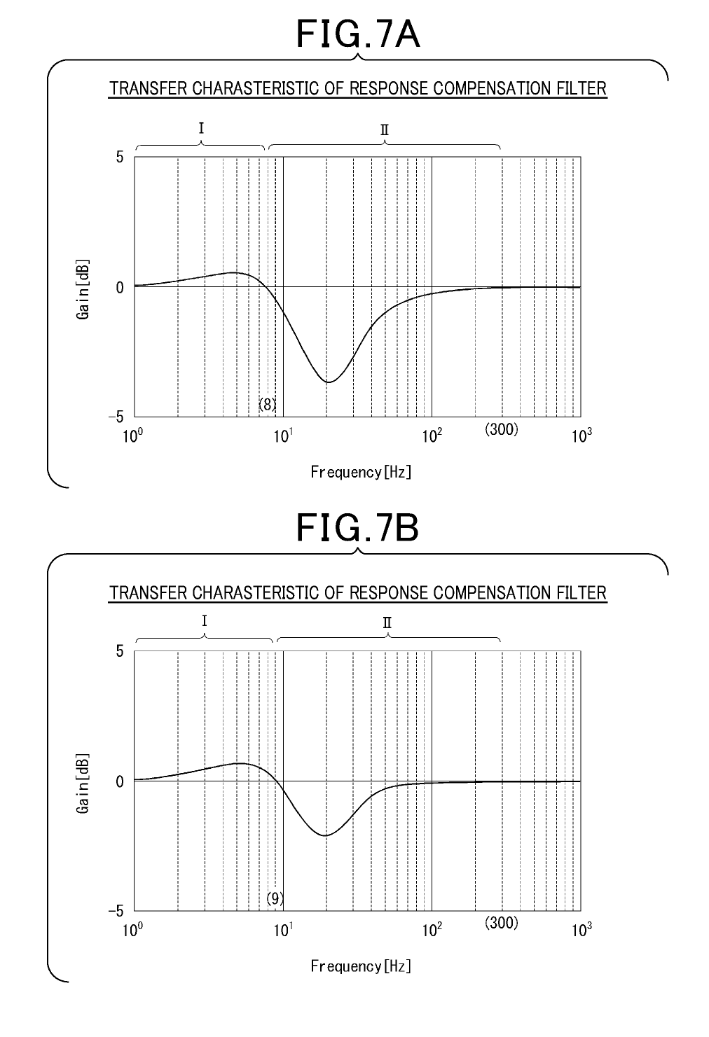

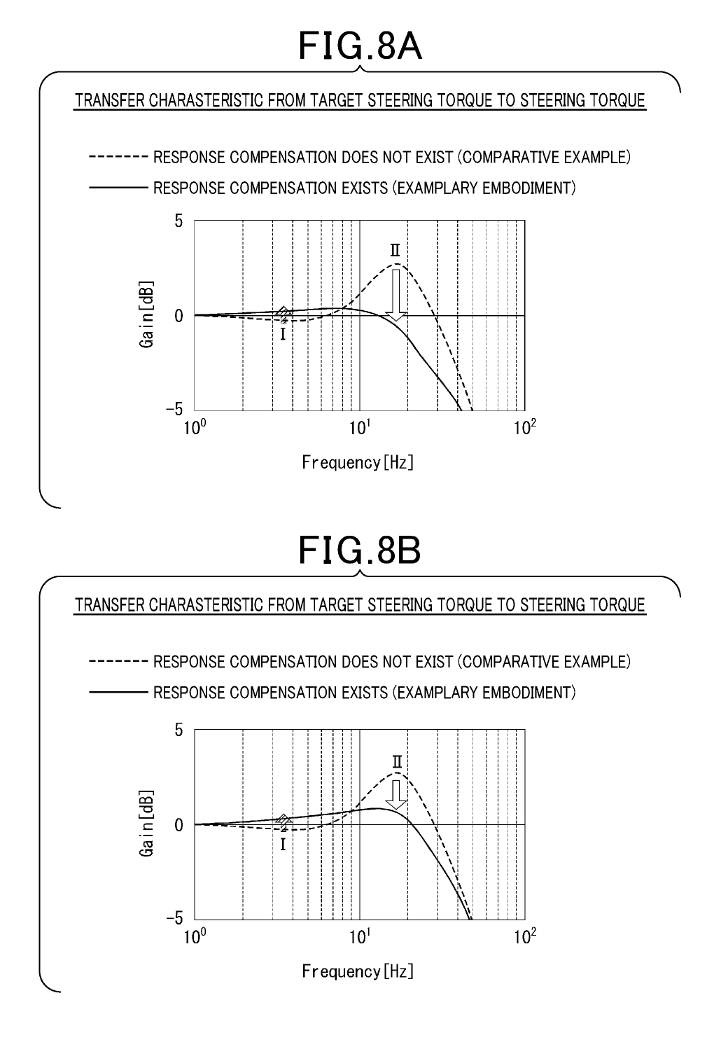

Apart from examples shown in FIGS. 5 and 6, two examples with respect to the transfer characteristic of the response compensation filter and the transfer characteristic from the target steering torque to the steering torque are respectively shown in FIGS. 7A and 7B and FIGS. 8A and 8B as second and third exemplary embodiments.

The transfer characteristics of the second and third exemplary embodiments are the same as the first exemplary embodiment in that reducing the rough feeling by suppressing the mechanical resonance characteristic and improving the response by enhancing the responsiveness are pursued. However, degrees of the resonance suppression and responsiveness improvement are different depending on the respective exemplary embodiments.

The transfer characteristic of the second exemplary embodiment is shown in FIGS. 7(a) and 8(a).

The transfer characteristic of the response compensation filter according to the second exemplary embodiment is set as follows:

(I) A gain is to be slightly increased at a band ranging from about 1 to 8 Hz; and

(II) A gain is to be relatively significantly decreased at a band ranging from about 8 to 300 Hz as a negative peak of about 20 Hz.

Accordingly, the transfer characteristic from the target steering torque to the steering torque according to the second exemplary embodiment is changed with respect to the transfer characteristic of the comparative example as follows:

A change of (I) is shown with a hatched block arrow, and a change of (II) is shown with an outlined block arrow in FIG. 8(a); and

(I) As the frequency becomes higher, the gain is smoothly increased at a range slightly higher than 0 [dB] at the band ranging from about 1 to 8 Hz. Meanwhile, the negative gain in the comparative example is increased until 0 [d B], that is, a value slightly higher than 1 time at the band ranging from about 1 to 7 Hz. The absolute value of the positive gain in the comparative example is increased at the band ranging from about 7 to 8 Hz. Accordingly, the responsiveness is improved, and thus consequently the response in the process of the steering is improved.

(II) The positive gain is decreased at the band ranging from about 8 to 30 Hz. Meanwhile, the gain is decreased in a positive value and becomes 0 [dB], that is, a value slightly higher than 1 time at the band ranging from about 8 to 12 Hz. The gain is decreased until 0 [dB], that is, the negative value slightly lower than 1 time at the band ranging from about 12 to 30 Hz. Accordingly, the mechanical resonance characteristic is suppressed, thereby reducing the rough feeling in the process of the steering.

The transfer characteristic of the third exemplary embodiment is shown in FIGS. 7(b) and 8(b).

The transfer characteristic of the response compensation filter according to the third exemplary embodiment is set as follows:

(I) A gain is to be slightly increased at a band ranging from about 1 to 9 Hz; and

(II) A gain is to be relatively significantly decreased at a band ranging from about 9 to 300 Hz as a negative peak of about 20 Hz. However, a degree of the gain decrease is smaller than that of the second exemplary embodiment.

Accordingly, the transfer characteristic from the target steering torque to the steering torque according to the third exemplary embodiment is changed with respect to the transfer characteristic of the comparative example as follows:

A change of (I) is shown with a hatched block arrow, and a change of (II) is shown with an outlined block arrow in FIG. 8(b); and

(I) The same change as the second exemplary embodiment is shown at the band ranging from about 1 to 9 Hz. More specifically, a boundary frequency of a band (II) shifts from about 8 Hz to 9 Hz at the band ranging from about 1 to 9 Hz with respect to the second exemplary embodiment. Accordingly, the responsiveness is improved, and thus consequently the response in the process of the steering is improved.

(II) The positive gain is decreased at the band ranging from about 9 to 30 Hz. Meanwhile, the gain is decreased in a positive value and becomes 0 [dB], that is, a value slightly higher than 1 time at the band ranging from about 9 to 20 Hz. The gain is decreased until 0 [dB], that is, the negative value slightly lower than 1 time at the band ranging from about 20 to 30 Hz. In the third exemplary embodiment, the gain becomes positive at the band ranging from about 1 to 20 Hz, and in comparison with the second exemplary embodiment, a band, where the gain becomes positive, expands to the higher frequency side. Accordingly, the mechanical resonance characteristic is suppressed, thereby reducing the rough feeling in the process of the steering.

In the second and third exemplary embodiments, the band of (II) is the frequency band suppressing the mechanical resonance characteristic. Additionally, the responsiveness is equally improved as the first exemplary embodiment at the band of (I) corresponding to the band of the frequency side lower than the frequency band suppressing the mechanical resonance characteristic.

However, in the second and third exemplary embodiments, a gain at “the band of the frequency side higher than the frequency band suppressing the mechanical resonance characteristic” of “the transfer characteristic from the target steering torque to the steering torque” is smaller than the gain of the comparative example. Accordingly, a characteristic at the band of (III) in the first exemplary embodiment is different from that of the second and third exemplary embodiments, and thus the responsiveness may not be improved at the band of the frequency side higher than the frequency band suppressing the mechanical resonance characteristic.

When the transfer characteristic of the response compensation filter 50 is set in a real vehicle, the most appropriate characteristic may be selected from a characteristic close to any one of the first to third exemplary embodiments and a characteristic combining characteristics of the first to third exemplary embodiments according to a characteristic of a vehicle or a sensitivity of a driver. An optimized steering feeling for the vehicle and the driver is able to be accomplished by appropriately selecting effect degrees of the resonance characteristic and the responsiveness improvement which are obtained by the response compensation of the target steering torque Ts*.

### Other Exemplary Embodiments

(1) A configuration of the response compensation filter is not limited to what is combined with the plurality of the band-pass filters shown in FIG. 3, and may be appropriate if a gain at a specific frequency band is able to be increased and decreased.

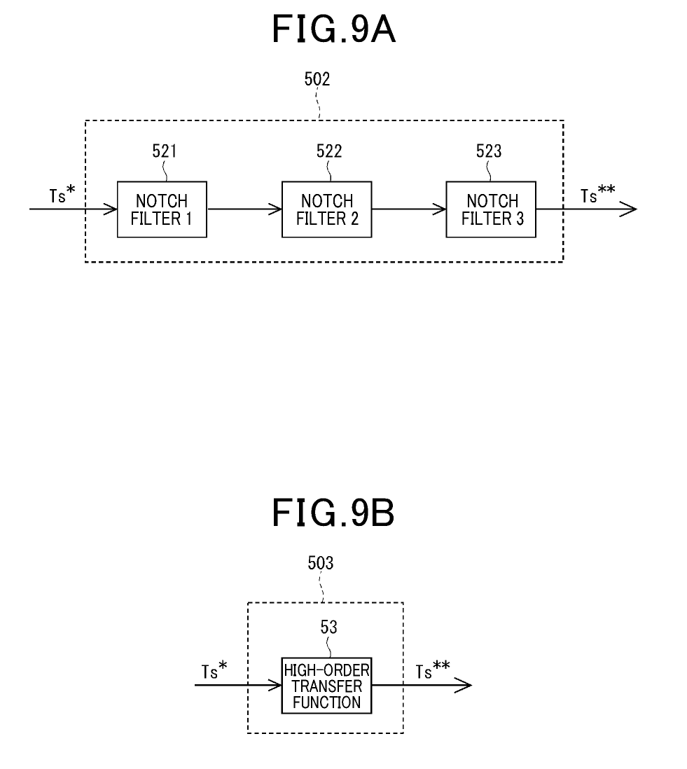

In the case of the response compensation filter 502 shown in FIG. 9A, a plurality of notch filters 521, 522, and 523 having different stop bands are configured to be connected in series.

The response compensation filter 503 shown in FIG. 9B is configured by a high-order transfer function 53.

Strictly speaking, the transfer characteristic does not completely correspond thereto by means of a configuration of the respective response compensation filters.

However, in consideration of an objective of the present invention for improving the steering feeling, it is possible to accomplish the transfer characteristic where substantially almost same effect is able to be obtained.

(2) As an input of the adder 21 of the load estimator 20 in FIG. 1 according to the exemplary embodiment, the steering torque Ts may be used instead of the target steering torque Ts*. Furthermore, a detection value of the assist torque may be used instead of the assist torque command value Ta*. In addition, a load may not be estimated but be directly detected.

(3) For example, a configuration of a torque compensation unit compensating for the steering torque Ts based on a motor speed w is described in FIG. 2, and the like of Patent Document 1. The steering control device of the present invention may be also provided with the same torque compensation unit. In this case, the assist torque command value Ta* in the specification may be replaced by a base assist command before a compensation torque is added.

The present invention should not be limited to the aforementioned exemplary embodiments, and is intended to cover various modifications included within the spirit and technology scope of the present invention.

### DESCRIPTION OF SYMBOLS

10 . . . ECU (Steering Control Device)
40 . . . Target Generation Unit
50 (501, 502, 503) . . . Response Compensation Filter
80 . . . (Steering Assist) Motor
100 . . . Steering System Mechanism

What is claimed is:

1. A device controlling an assist torque to be outputted by a motor connected to a steering system mechanism generating a steering torque, comprising:
a target generation unit generating a target steering torque, which is a target value of the steering torque;
a response compensation filter where a filter process compensating for a response at a specific frequency band with respect to the inputted target steering torque is performed, and a response-compensated target steering torque is outputted; and
a servo controller calculating a command value of the assist torque in order for a torque deviation, which is a difference between the steering torque and the target steering torque after compensating for the response, to become zero,
wherein the response compensation filter has a transfer characteristic which is set to suppress a mechanical resonance characteristic at a frequency band having the mechanical resonance characteristic where a gain due to resonance of the steering system mechanism becomes great, with respect to a transfer characteristic from the target steering torque to the steering torque.

2. The device according to claim 1, wherein the transfer characteristic of the response compensation filter is set to increase a gain of the transfer characteristic from the target steering torque to the steering torque in a band of a frequency side lower than a frequency band suppressing the mechanical resonance characteristic.

3. The device according to claim 1, wherein the transfer characteristic of the response compensation filter is set to increase the gain of the transfer characteristic from the target steering torque to the steering torque in a band of a frequency side higher than the frequency band suppressing the mechanical resonance characteristic

4. The device according to claim 1, wherein the response compensation filter is configured by a plurality of band-pass filters.

5. The device according to claim 2, wherein the transfer characteristic of the response compensation filter is set to increase the gain of the transfer characteristic from the target steering torque to the steering torque in a band of a frequency side higher than the frequency band suppressing the mechanical resonance characteristic

6. The device according to claim 2, wherein the response compensation filter is configured by a plurality of band-pass filters.

7. The device according to claim 3, wherein the response compensation filter is configured by a plurality of band-pass filters.

8. A method of controlling an assist torque to be outputted by a motor connected to a steering system mechanism generating a steering torque, comprising steps of:
generating a target steering torque, which is a target value of the steering torque;
performing a filter process compensating for a response at a specific frequency band with respect to the inputted target steering torque is performed, and a response-compensated target steering torque is outputted; and
calculating a command value of the assist torque in order for a torque deviation, which is a difference between the steering torque and the target steering torque after compensating for the response, to become zero,
wherein the response compensation filter has a transfer characteristic which is set to suppress a mechanical resonance characteristic at a frequency band having the mechanical resonance characteristic where a gain due to resonance of the steering system mechanism becomes great, with respect to a transfer characteristic from the target steering torque to the steering torque.
